(19) United States
(12) Patent Application Publication
(10) Pub. No.: US 2008/0046833 A1
(43) Pub. Date: Feb. 21, 2008

(54) CONTENT AND PRINT PRODUCTION MANAGEMENT SYSTEM AND METHOD

(75) Inventors: Kevin Patz, Manchester, NH (US); Jean Grant, Londonderry, NH (US); Sheila LaRoche, Beford, NH (US); Anissa Gillis, Nashua, NH (US); Marilyn Santarelli, Salem, NH (US); Denise M. Miano, Salem, NH (US); Kevin Buckley, Derry, NH (US); Vincent James Iacomino, Sandown, NH (US)

Correspondence Address: DUANE MORRIS, LLP;IP DEPARTMENT, 30 SOUTH 17TH STREET, PHILADELPHIA, PA, 19103-4196, US

(73) Assignee: NEPS, LLC, Salem, NH (US)

(21) Appl. No.: 11/839,147

(22) Filed: Aug. 15, 2007

Related U.S. Application Data
(60) Provisional application No. 60/822,452, filed on Aug. 15, 2006.

(51) Int. Cl. G06F 3/048

(52) U.S. Cl. 715/769

(57) ABSTRACT

A software system and method for managing creation, management and print production of a production asset comprising a content management module and a print production manager integrated with the content management module includes a web browser-based drag-and-drop interface provided at a user location for defining a workflow for the production asset. The system includes a central repository for storing the production assets in which the print production management system uses the same copy of the production asset as is used by the content management module.

### CROSS REFERENCE TO RELATED CASES

This is a U.S. non-provisional application of U.S. provisional patent application Ser. No. 60/822,452, filed Aug. 15, 2006, the entirety of which application is incorporated herein by reference.

### FIELD OF THE INVENTION

The present invention relates to a content management system for and more specifically combines enterprise content management (ECM) with print production and distribution.

### BACKGROUND

A content management system is generally a software system designed to manage the process of creation of documents and their content (raw text, images, rich media, etc.). A content management system allows controlled access of the documents from their repository by the users for revising and updating, etc. Once the documents are completed and approved for production, the approved documents are available for production.

In today's environment, driven by the high speed information communication technologies, there is a continuing demand to decrease the cycle time from receiving a customer order to the delivery and archival of the final print product.

### SUMMARY

According to an embodiment, a software system for managing creation, management and print production of a production asset is disclosed. The system comprises a content management (CM) module and a print production manager integrated with the content management module. A web browser-based drag-and-drop interface is provided at a user location for defining a workflow for the production asset and a central repository for storing the production assets in which the print production manager uses the same copy of the production asset or production content as is used by the content management module. The terms “production asset,” “production content” and “content” will be used interchangeably throughout this document.

According to another embodiment, a method of managing creation and print production of a production asset is disclosed. The method comprises providing a plurality of content management tools for managing the storage of and controlled access to the production asset, then configuring a print production workflow to operate in concert with the plurality of content management tools during a print production process to control development, distribution, and access of the documents. The step of configuring a print production workflow includes providing a web browser-based drag-and-drop interface to the end user for defining a workflow for the production asset. The completed production assets, documents, are stored in electronic form in a central repository, wherein the production contents are entered into the content management module and re-purposed into the print production manager and the print production manager uses the same copy of the production content as is used by the content management module.

By directly linking content management with production management the ECM system described herein provides an extremely powerful capability for all constituents along the content lifecycle and supply chain.

### BRIEF DESCRIPTION OF THE DRAWINGS

FIG. 1 is a schematic process flow illustrating the software system for managing creation, management and print production of a production asset according to an embodiment.

FIG. 2 is a schematic process flow illustrating the order submission process of the software system of FIG. 1.

FIG. 3 is a schematic process flow illustrating the operation of the multi-queue manager of the software system of FIG. 1.

FIGS. 4-8 shows one implementation of the workflow browser interface.

The features shown in the above referenced drawings are illustrated schematically and are not intended to be drawn to scale nor are they intended to be shown in precise positional relationship. Like reference numbers indicate like elements.

### DETAILED DESCRIPTION

In the following detailed description of the preferred embodiments, reference is made to the accompanying drawings which form a part hereof, and in which are shown by way of illustration specific embodiments in which the invention may be practiced. It is to be understood that other embodiments may be utilized and changes may be made without departing from the scope of the present invention.

In the description provided herein, the term “print”, “printing”, etc. is used to refer to a document being produced in traditional print format or rendered into other final medium requested by the user or customer ordering a document. The final medium can be, for example, traditional print media such as paper, fabric, metal, wood, etc. The final medium also can be other non-print media such as electronic form displayed on a display screen for electronic publishing, or a computer readable storage medium, such as a flash drive, a CD-ROM, a DVD-ROM, a floppy disk, or the like.

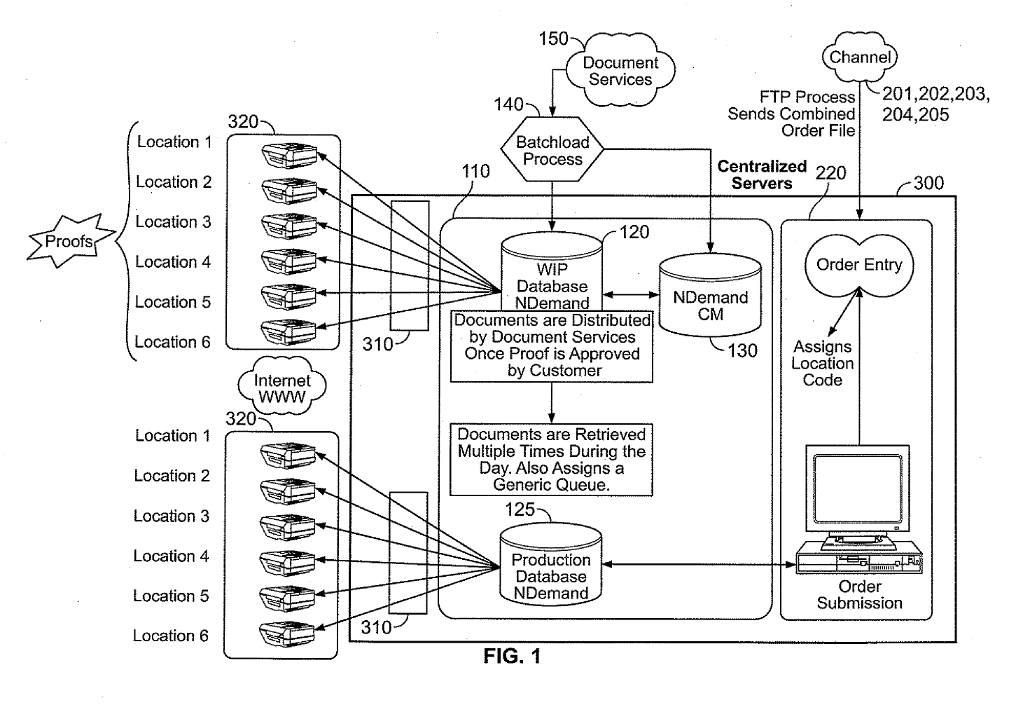

Referring to FIG. 1, the unique attributes of the present system will be described. The CM repository 130 is the central repository for all documents and associated assets loaded from the batch load process 140. A batch load process 140 is a module (or set of modules) that provides the user 150 (e.g., a document services group) the ability to load content into the CM repository 130 in a batch environment. The batch load process 140 contains information (metadata) that is used to categorize documents into the CM repository 130, bypassing the online data entry facilities. In one embodiment, one or more users 150 (e.g., a document services person or group) are responsible for loading the CM repository 130 by way of the batch load facility 140 and/or online data entry. The exemplary system allows either or both methods to be used. The system also provides the capability for one or more users 150 (e.g., the document services person or group) to create the document templates and associated graphics. Possible users include but are not limited to:
Plant operators
Document composition
Procurement personnel

A work-in-progress (WIP) database 120 allows production jobs to be sent to the production systems 320 to be proofed for production readiness. The production systems 320 can be print vendors, for example, or the customer's own production system. Once the proof is approved by the customer, the production manager moves the job content, the document file, to the production database 125.

The collection of the production ready documents maintained in the production database 125 is accessed by the production manager 300 to fulfill the job orders coming in from the order submission module 220. When a job order is received by the order submission module 220 of the production manager 300, the order submission module 220 accesses the production database 125 for the document or documents that were ordered and identifies the target print queue 240 according to the applicable business rules 230. From the print queue 240, the document(s) are sent to the appropriate target production systems 320.

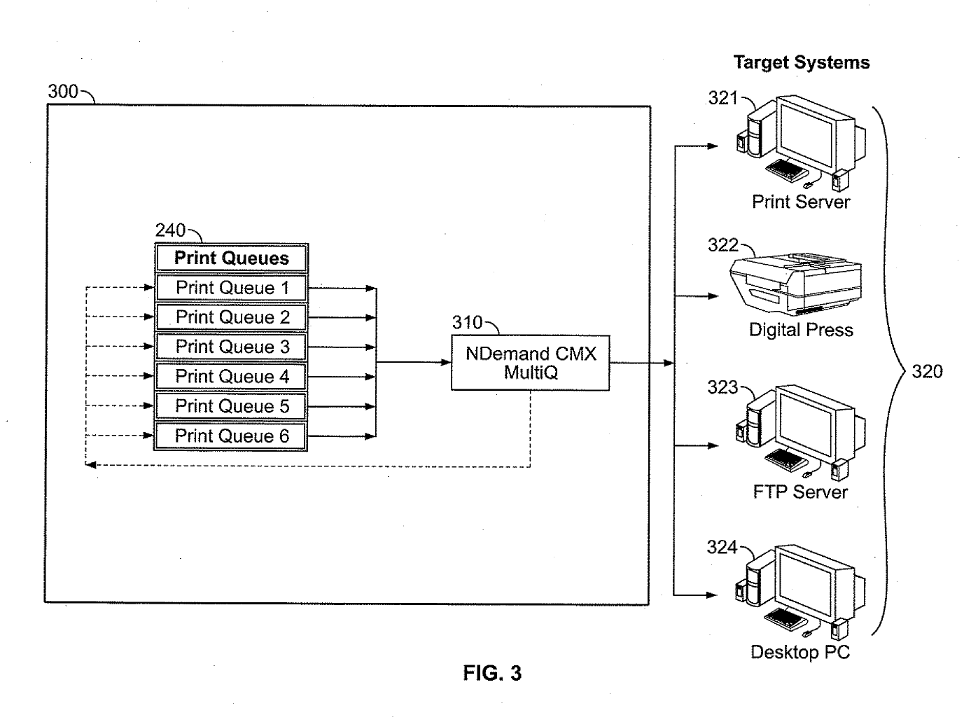

A multi-queue manager 310, described in more detail below in reference to FIG. 3, manages the transmission/routing of the proof jobs from the WIP database 120 to the appropriate production systems 320 as well as the transmission/routing of the production jobs from the production database 125 to the appropriate production systems 320.

The exemplary system features a centralized repository capable of supporting the entire enterprise. Here, the centralized repository refers to one or more databases as well as the associated content. The central repository, which is a collection of production ready content, is integrated to the production fulfillment system in such a way that the metadata supporting the content delivery is defined to the production manager. Requests for print/view are easily obtained and the output characteristics are consistent and maintained at the content level (e.g., plex, finishing options, tab inserts, binding, stock or the like, and manual offline functions such as, but not limited to, shrink wrapping.)

In this way, the production content (assets) can be entered into the content management system and repurposed into the production management system while maintaining one iteration (copy) of the production content. Then the production management system can use the same copy of the content that is used by the content management system for fulfillment (e.g., production and/or distribution).

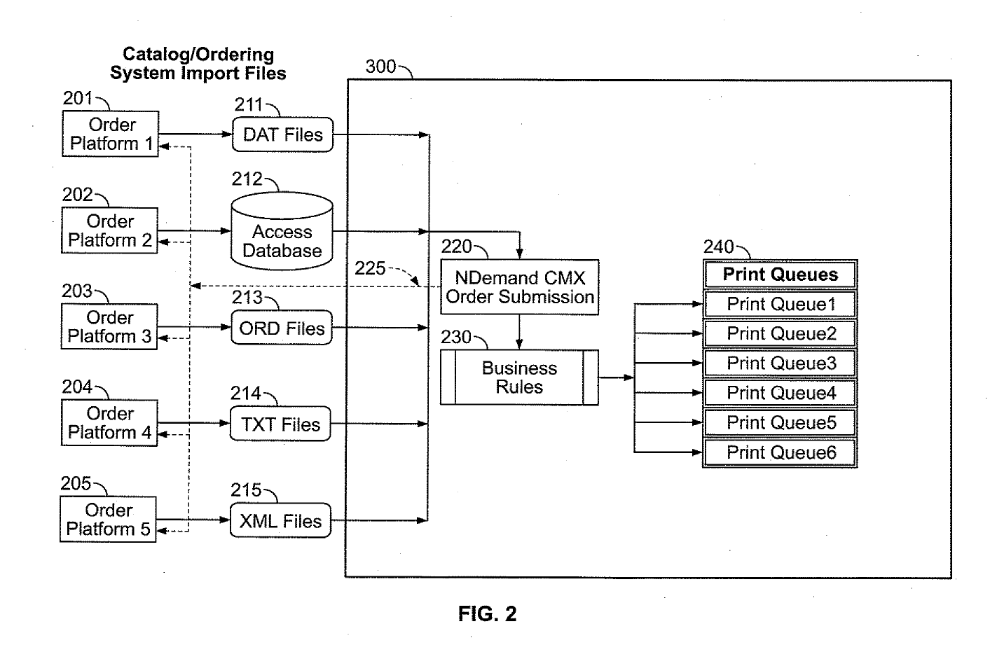

Referring to FIG. 2, the operation of an order submission module of the production manager according to one implementation will be described. The order submission module enables the exemplary system to accept orders from disparate ordering systems to be processed through production. Order files 211, 212, 213, 214, 215 from third party catalogs/ordering systems 201, 202, 203, 204, 205 are generally unique, as are the business requirements for processing these orders. For example, each of the order files 211, 212, 213, 214, 215 can have one of various different formats, such as “dat”, “ord”, “txt”, “xml”, comma delimited, fixed length, flat files, Microsoft Access database, etc. The present system contains an order submission module 220 capable of accepting orders in any of these formats, but other formats may be supported as well. The order submission module 220 automatically imports the orders and submits them to the appropriate system print queues 240 based on customer specific business rules 230.

The order submission module 220 processes the order files from the third party catalogs/ordering systems 201, . . . 205 based on a pre-defined format. The order submission module 220 imports the order to the production manager module and pulls the file and applies all order information to a job ticket. Examples of the information that can be specified in the order information are quantity, any special instructions, identification of the particular facility to print the job.

The business rules 230 assist in the routing of the orders to the appropriate print queue, which may be part of the production manager. The business rules 230 can identify target print queues for each order based on user requirements as well as specific print specifications. The business rules 230 can control the generation of dynamic kits. The dynamic kit module allows the system to put any combination of documents together into a print production job on the fly based on pre-defined business rules (i.e., predefined business rules are used in the generation of the dynamic content in a real-time manner). This process can be used for variable as well as static data streams. Static data streams are constant (always producing the same content), whereas dynamic streams are changeable and or customized. Based on business rules and or data stream content the system can construct a different data stream. The business rules also control the generation of related materials, such as, shipping sheets, shipping labels, print specifications and manage input/output URLs. Business rules are user defined and custom, based on the particular customer installation. Within the administration section of the application system, the system administrators have the ability to define where the production jobs should print based on location or print specifications. Other business rules that are “customer” specific are custom coded.

The content can be managed from different locations based on the concept of a distributed architecture (content disbursed among many server locations) using uniform resource locators (URLs)

After receiving the order, the order submission module 220 can automatically transmit electronic acknowledgements, such as email messages, of receipt of orders to the originating third party catalogs/ordering systems.

Referring to FIG. 3, a multi-queue manager 310 is disclosed. The multi-queue manager 310 can be used by the production system owner. The multi-queue manager 310 is a module of the print production manager 300 and is configured to handle the conversion of the production document file format into and from any of the variety of technologies/formats used by the production systems. The multi-queue manager 310 provides multi-threaded capability transmitting production jobs from the print production manager's print queues using various protocols such as TCP/IP, FTP, LPR, NFS, etc.

The multi-queue manager 310 thus allows customers to transmit jobs using the particular technology/format compatible with their system, operating with a particular protocol regardless of the technology/format required by the final (or the target) production system. This makes the present system an extremely robust application allowing the customers to control the number of threads allowing more efficient transmission of jobs.

The target production systems 320 receiving the production jobs can comprise many different types of machines producing the final production in a variety of formats. For example, the target production systems 320 can be print servers 321, digital presses 322, FTP sites 323, PC directories 324, etc. The provision of the multi-queue manager 320 provides the present system the ability to support multiple job ticket structures for various printer technologies including Xerox, IBM, Heidelberg, Canon, Indigo, CREO, Kodak and Soleil, for example.

The multi-queue manager 310 can be configured to receive production job status from the target production systems 320. The print production manager 300 can then use the job status information from the target production systems to manage the print queues so that if a particular target production system is busy, if possible, some of the production jobs can be directed to a print queue for a different but appropriate target production system.

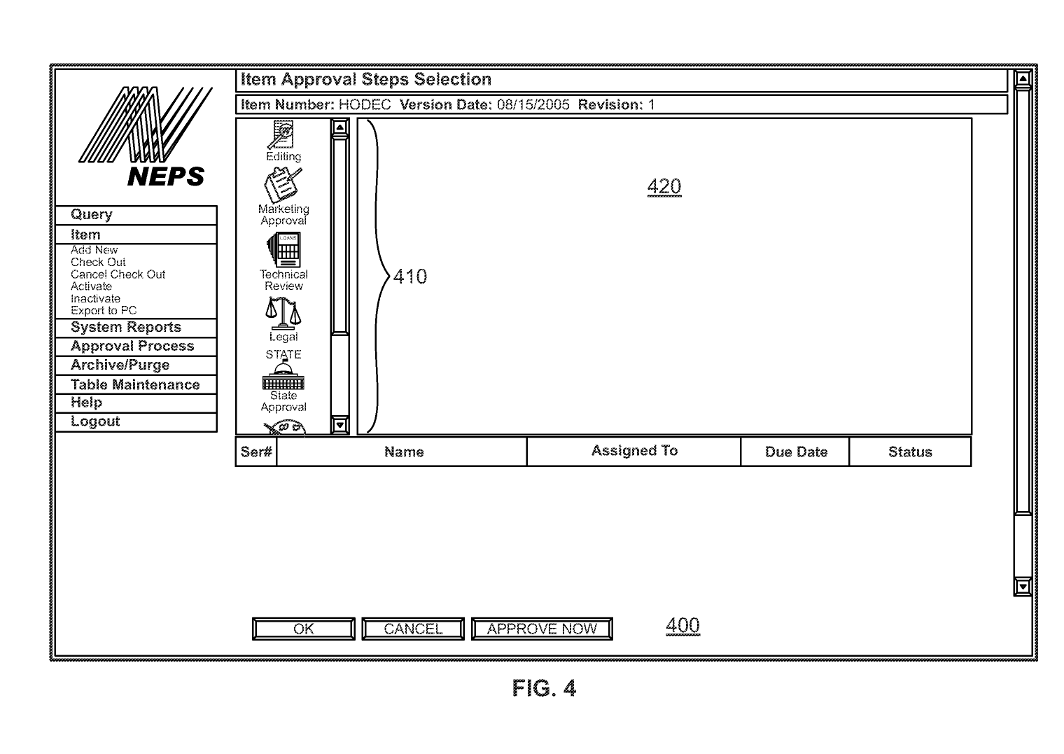

The workflow module is part of the content management system. The workflow component is used during the check-in process of the managed content. A workflow can be assigned by the entity introducing the content for approval within the organization. Referring to FIGS. 4-8, a workflow solution provided by the workflow module of the present system will be described. One implementation of the system provides innovative drag-and-drop capabilities within the web browser-based thin clients to create workflow definitions that can be assigned to forms. Here, the term “forms” refers to content, for example a word form, excel spreadsheet, Visio diagram, a Video, audio, or any combination. In the example 201-205 refer to external ordering/catalog systems. The exemplary system has a thin client interface to the workflow assignment. The thin client workflow component is invoked during the content introduction process. Once the content is approved, then the content is made available to the third party ordering/catalog system.

This ability to drag-and-drop within a web browser-based client is unique to the present system. The workflow module provides an efficient and simple way to set up workflows that will ensure forms are reviewed and approved before being sent to a production run environment. When a new document is introduced and workflow is assigned, the document is not yet available for ordering for final production.

The system provides a structured process for introducing documents into the system and for assigning the workflows. In one example, the document may be introduced to the system by users within a document creation department of a company. This could include the graphic arts department and or the business owners.

If a document is ordered from the third party application, there are edits in place to inform the end user that the document is not yet ready for ordering. Once the document is approved, a flag is set to allow the order to be created. Once a final approval is given the content owner can control who and how many copies the customer can order. The term “content owner” refers to the department and/or business entity (unit or person) within the organization which is responsible for the creation, introduction assignment of workflow and modification of the content, and can differ from the legal owner of the copyright in the content. This information is supplied during the setup of the item within the CM module, where “Item” refers to a content, for example a Word form, Excel spreadsheet, Visio diagram, a Video, audio, or any combination thereof.

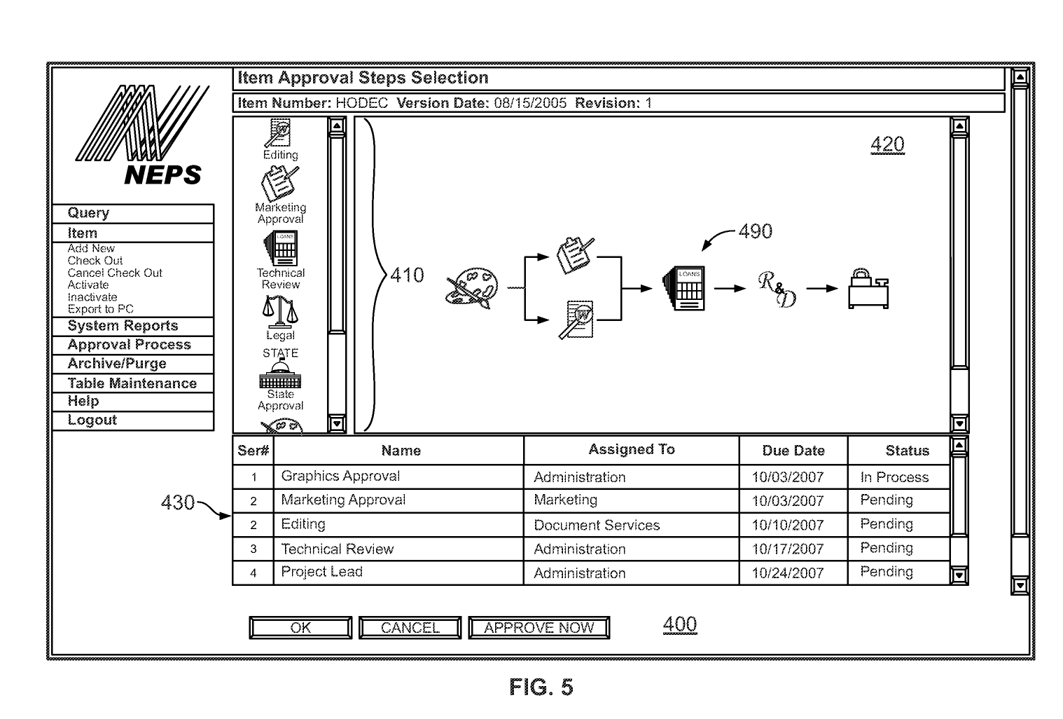

The workflow module provides the thin client user with a web browser based workflow user interface 400 illustrated in FIGS. 4-9 for defining the workflow for a particular document to be created. The workflow user interface 400 comprises a work area 420 and a catalog of approval step icons 410 for building a customized workflow. The user clicks on a desired Approval step icon, drags it over and drops the icon into the work area 420. The workflow user interface allows the user to create either a serial workflow, a parallel workflow, or a combination of the two. Referring to FIG. 5, as the workflow 490 is built by dragging and dropping icons into the work area, a “chart” representation 430 of the workflow will be generated below the icon version.

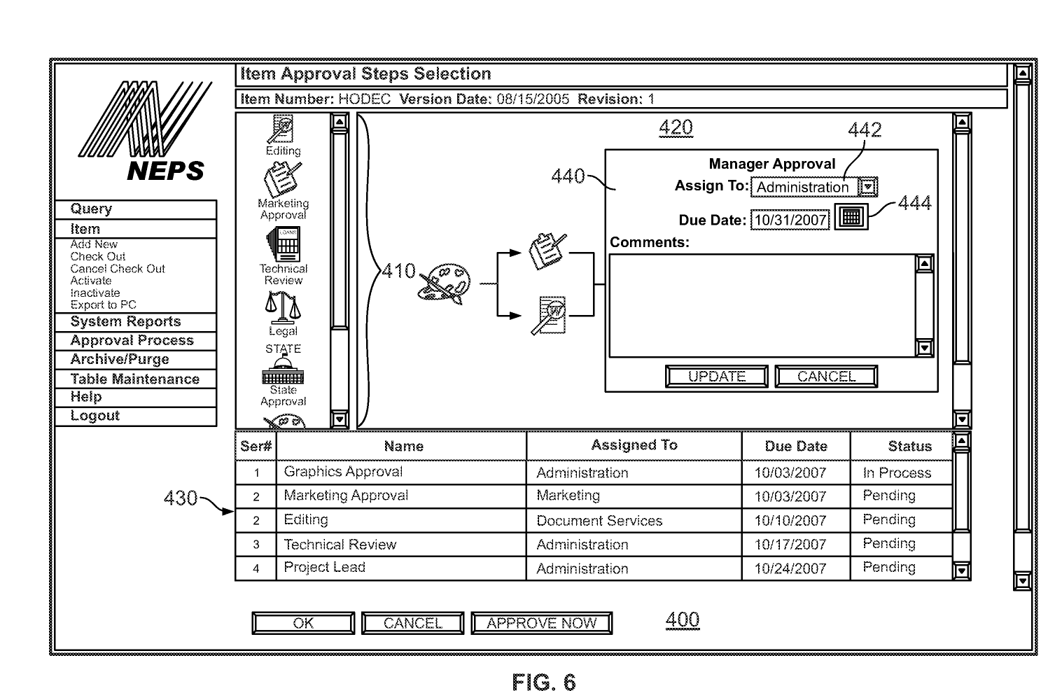

According to an embodiment, the approval steps can be assigned by default to the department owning the step and this information can be stored in a Table Maintenance provided in the present system. According to another embodiment, the user can, during the workflow building process, identify a particular individual (e.g., an employee within the department) responsible for approving that step. Referring to FIG. 6, the workflow user interface can be configured so that when the user clicks on a particular approval step icon in the work area or clicks on one of the fields in the chart 430, an approval box 440 will be presented where an individual can be chosen from a drop-down list 442 of all users in that department.

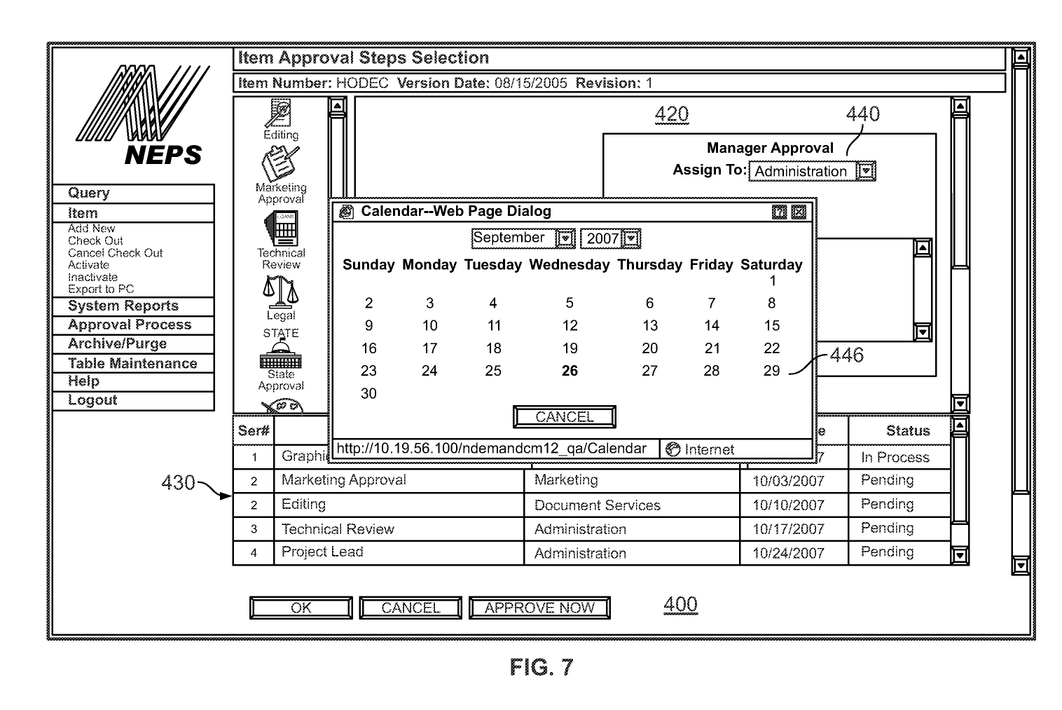

Generally, each approval step in the workflow would have a due date associated with the completion and approval of that step. According to an embodiment, the workflow user interface 400 is configured to allow the user to modify the due date for a given approval step by clicking the calendar icon 444 next to the “Due Date” window in the approval box 440. FIG. 7 is an exemplary illustration of a calendar 446 presented to the user when the calendar icon 444 is selected. The user can select a new date by selecting the desired month and clicking on the desired date. According to an embodiment, the application is coded so that the user may not enter a date that is earlier than the present date the workflow is being assigned or created.

The due date for the first step or group of parallel steps is calculated based on the number of days assigned in the “Approval Options” portion of Table Maintenance. The present system calculates the total duration deadline of the workflow based on the critical path. This number of days is then used to calculate the due dates for subsequent sets of steps. If a due date is modified, all due dates in subsequent sets of steps will be modified.

For each step in the workflow, the present system enables setting up an escalation path in case that step was not performed by the specified deadline. The escalation path refers to the management path to be followed to escalate the issue to the attention of higher management in the business that is creating the new document. The issue in this example being a particular step in the workflow being delayed.

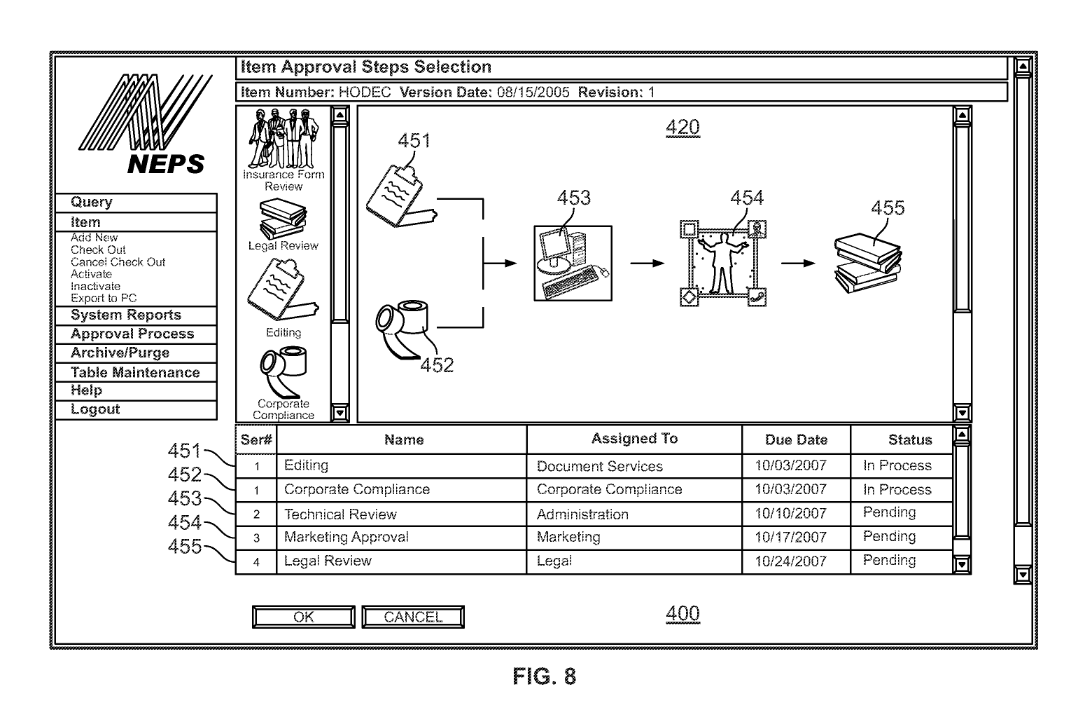

Referring to FIG. 8, the workflow can have both parallel approval steps as well as serial workflow steps. The workflow shown in FIG. 8, for example, has approval steps 451 and 452 happening in parallel and the subsequent approval steps 453, 454 and 455 happening serially. Parallel workflow means that multiple steps can be occurring at the same time and one step can be approved without waiting for another. Serial workflow, on the other hand, means a step or a set of steps must be completed before the next step(s) can begin. For this reason, changing a due date for one of the steps within a parallel workflow portion will not affect the due dates of the remaining steps in that flow.

According to an embodiment, the present system can be configured so that an email notification is sent to the user assigned to an approval step when the preceding step or a set of steps are completed and properly approved. If an individual was not assigned to that approval step, the head (i.e. the manager) of the department responsible for that approval step head will receive the email. For a serial workflow, all approval steps in the serial workflow preceding a particular approval step must be completed before an email notice is generated for the next step or set of steps. The email notices are sent by the workflow module based on the workflow with a reply email address that the system can receive and parse to know that the workflow step was done.

According to an embodiment, the present system can be configured so that the email recipient can approve or disapprove the step from within their email system or by logging into a controlled-access interface application. If the step is approved or disapproved via email, an update is forwarded to the workflow module. If a workflow step is rejected (disapproved), all subsequent steps will be locked.

The present system provides the administrator with the ability to define the details of a print job and also manage the print queues. The present system also allows the administrator to give the users access to the print queues. This can be done by assigning each print queue to a plant code. Users can be assigned to multiple plant codes. Users have access to all queues belonging to plant codes to which the users are assigned and all jobs within these queues. In an embodiment, the user interface of the user's terminal is configured to provide the users with the ability to view the job ticket for any job in the print queue by highlighting the job and clicking on an appropriate button or a command field.

In one embodiment, the displayed job ticket information includes, but is not limited to:
Stock
Plex (duplex and simplex)
Tabular inserts
Cover page images
Finishing options
Number of copies
Binding and stapling options
Manual off line functions like shrink wrapping and trimming

Once jobs are printed, these jobs will remain accessible for reprint for a defined time period that can be controlled by the administrator.

The present system also provides the users the ability to add jobs to print queues or flush jobs from print queues to which the user has access. The user also may be allowed to move job(s) from one queue to any other queue to which the user has access by highlighting the job(s) in the queue and selecting the new destination queue. The moving or flushing of jobs from the print queues can be done in a batch. The user interface can be configured so that the user can highlight multiple jobs within a print queue and either flushing them or moving them as a group to another queue. In one embodiment, when jobs are moved between queues, the user is notified by on screen messages of any functionality differences between the source and destination queues and jobs are adjusted if the user chooses to proceed. Whether or not a particular user has the ability to do certain things such as adding jobs to a print queue can be managed by maintaining a user profile information in the system and controlled by the administrator.

Preferably, the default status of a new job placed in a print queue is “Held.” The ability to release the job for printing is managed in the user profile, controlled by the administrator. Once released for print, the user should have the ability to reset the job back to “Held” status.

The production manager 300 is configured to provide the user the ability to search a print queue or all print queues to which the user has access in order to find specific job(s). The search can be conducted by any one of the various attributes associated with the particular document(s). The search can be by the print job number assigned to the document in the print queue or by the document name or any other appropriate document attributes.

In order to better manage a queue, the user should be able to sort all of the jobs within a queue by one or more of the following: document name, job number, due date, or print status. Ascending and descending sorting should be available. The user also has the ability to filter jobs based on print specifications as well as other selection criteria such as the due date, the order status, color vs. B&W, etc. In this way the user can manage all jobs with similar print attributes. Any, All, or None logic should be available.

The ability to group “like jobs” when printing is available at a system level. This ability can be turned On/Off by the administrator. The user has the ability to place queues on Hold so that held jobs cannot be released for print. Print queues can also be “Disabled” so that new jobs cannot be placed into them.

The present system also provides the administrator with the ability to turn On/Off the printing of other related documents associated with the ordered document. These related documents can be Shipping Sheets, Shipping labels and/or Job Specification Sheet at a system level.

What is claimed is:

1. A software system for managing creation, management and print production of a production asset comprising:
a content management module;
a print production manager that is integrated with the content management module;
a web browser-based drag-and-drop interface provided at an end user location for defining a workflow for the production asset; and
a central repository for storing the production assets in which a copy of the production asset is stored, such that the copy of the production asset is accessible by the content management module and the print production manager.

2. A method of managing creation and print production of a production asset, the method comprising:
providing a plurality of content management tools for managing the storage of and controlled access to the production asset;
configuring a print production workflow to operate in concert with the plurality of content management tools during a print production process to control development, distribution, and access of the documents,
wherein the step of configuring a print production workflow includes providing a web browser-based drag-and-drop interface to the end user for defining a workflow for the production asset; and
storing the production assets in electronic form in a central repository, wherein the production contents are entered into the content management system and re-purposed into the print production management system, and the content management tools and the print production process operate on the same copy of the production content.
